(19) United States
(12) Patent Application Publication
(10) Pub. No.: US 2009/0077667 A1
(43) Pub. Date: Mar. 19, 2009

(54) METHOD AND DEVICE FOR HANDLING DIGITAL LICENSES

(75) Inventors: Bartholomeus Johannes Van Rijnsoever, Eindhoven (NL); Ivo Jan Willem Gerard Dijkhuis, Eindhoven (NL); Cornelis Edmond Heijmans, Eindhoven (NL); Rob Kuppens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/719,128

(22) PCT Filed: Nov. 4, 2005
(86) PCT No.: PCT/IB05/53616

§ 371 Date: May 11, 2007

(30) Foreign Application Priority Data
Nov. 11, 2004 (EP) 04105687.0

(51) Int. Cl. G06F 21/00

(52) U.S. Cl. 726/26

(57) ABSTRACT

A device and a corresponding method for handling digital licenses, each digital license being associated with one or more content items, said device comprising a processing unit adapted to: check whether a number of licenses, being associated with a single content item or copies thereof, are designated as a stray license, where the number of licenses are present on at least one device of a group of devices, and merge the license(s) designated as stray licenses into a merged single license if the number of stray licenses is larger than 1.

### FIELD OF THE INVENTION

The invention relates to a method of handling digital licenses. The invention further relates to a device for handling digital licenses. Further, the invention relates to a computer readable medium having stored thereon instructions for causing one or more processing units to execute the method according to the invention.

### BACKGROUND OF THE INVENTION

Recent developments in content distribution technologies (i.e. the Internet and removable media) make it much easier to exchange content than ever before. The rapid adoption by consumers shows that such technologies really address their needs. The content providers want protection for the copyright of the content/content item(s) that is brought into digital circulation. Therefore in recent years, the amount of content protection systems is growing in a rapid pace.

The concept of Authorized Domains (ADs) aims at finding a solution serving both the interests of the content owners (that want protection of their copyrights) and the content consumers (that want unrestricted use of the content item(s)). The basic principle is to have a controlled network environment in which content can be used relatively freely as long as it does not cross the border of the authorized domain. Typically, Authorized Domains are centered on the home environment, also referred to as home networks. Of course, other scenarios are also possible. A user could for example take a portable device for audio and/or video with a limited amount of content with him on a trip, and use it in his hotel room to access or download additional content stored on his personal audio and/or video system at home. Even though the portable device is outside the home network, it is a part of the user's Authorized Domain. In this way, an (device-based) Authorized Domain (AD) is a system that allows access to content by devices in the domain, but not by any other devices. Authorized Domains that are person-based and hybrid-based do also exist.

A home network can be defined as a set of devices that are interconnected using some kind of network technology (e.g. Ethernet, IEEE 1394, BlueTooth, 802.11b, 802.11g, etc.). Although network technology allows the different devices to communicate, this is not enough to allow devices to interoperate. To be able to do this, devices need to be able to discover and address the functions present in the other devices in the network. Such interoperability is provided by home networking middleware. Examples of home networking middleware are Jini, HAVi, UPnP (Universal Plug and Play), AVC.

For a more extensive introduction to the use of an Authorized Domain, etc., see S. A. F. A. van den Heuvel, W. Jonker, F. L. A. J. Kamperman, P. J. Lenoir, Secure Content Management in Authorised Domains, Philips Research, The Netherlands, IBC 2002 conference publication, pages 467-474, held at 12-16 Sep. 2002.

Further, there are several variations of an AD. In so-called device based ADs, the domain is formed by a specific set of devices and content. A domain manager (one or more of the devices) controls which devices may join the domain. Only the specific set of devices of the domain is allowed to make use of the content of that domain, e.g. to open, copy, play or export it. Examples of such device-based ADs are given in international patent application WO 03/098931 (attorney docket PHNL020455) and international patent application WO 04/027588 (attorney docket PHNL030283) by the same applicant.

Another type of AD is the so-called person based Authorized Domains, where the domain is based on persons instead of devices. An example of such a system is described in international patent application WO 04/038568 (attorney docket PHNL021063) by the same applicant, in which content is coupled to persons, which then are grouped into a domain.

A so-called Hybrid Authorized Domain-based DRM system ties content to a group that may contain devices and persons. Examples of hybrid AD systems can be found in international patent application serial number PCT/IB2004/051226 (attorney docket PHNL030926) and in European patent application serial number 04101256.8 (attorney docket PHNL040315).

In this way, an Authorized Domain (AD) is a collection of devices and/or users that share (controlled) access to a number of content items being part of the domain. Members of the AD (i.e. devices and/or users) have access to the content (additional restrictions like restricted to viewers 18 years or older, European market only, etc. may apply as specified in a license, a (digital) right, etc.) while non-members do not have access. A device or user is typically only member of one AD at the most. Content items are typically delivered to the AD under the control of a DRM system. Several types of DRM systems may deliver content to a single AD.

The access to these content items within an AD is usually controlled using licenses, rights, etc. Depending on design choices, an AD may e.g. be a distributed system where several devices in the AD store and maintain licenses, rights, or the like e.g. in addition to the actual content item(s). Rights and/or licenses, etc. may be stateless or stateful (i.e. comprising a specific state for a right/license associated with the content item). One example of a state is e.g. a number of allowed play backs of a content item. Such stateful licenses/rights are sometimes referred to as countable rights, i.e. rights associated with a number of uses, accesses, renderings, viewings, etc. A single Authorized Domain (AD) could comprise both stateless and stateful licenses. If a right, license, etc. for a given content item is stateless, e.g. it does not count the number of play back rights whereby the content item can be played as many times as requested within the AD, the associated license, right, etc. (and e.g. the associated content item) can be copied to multiple devices (within the domain). However, if a license, right, etc. is stateful then restrictions do apply on copying a license, right, etc. (and e.g. the associated content item) by splitting the relevant license. As an example, a license comprising a right allowing 5 times of play back of a given content item can be split into a license allowing 2 times of play back and a license allowing 3 times of play back. This situation may as an example e.g. occur when a user brings a portable device being a member of the Authorized Domain (AD) with him on a trip in order to render, play back, etc. a given content item (having an associated stateful license/right), which is also copied to the portable device (e.g. with no or limited network functionality/bandwidth) to allow for local access, rendering, play back, etc. while away on the trip and still enabling other users/devices of the domain (e.g. at home) to still be able to access the content item as well. In this situation, the stateful license/right of the content item needs to be split so that one split license/right is copied to the portable device (e.g. together with the content item) while the other split license/right stays stored on one or more devices of the AD (e.g. at home). Other situations could e.g. be when several users (of the AD) want to be able to access a given content item on their individual portable device and so on.

In such an environment a system or device may easily loose track of licenses/rights, which can result in a situation where the user is not allowed to play a given content item although a valid license/right (forth only denoted license) still exists within the AD, since the license cannot be located by the system. This holds especially for distributed systems as mentioned above and/or for systems comprising a large number of content items. Further, at the time of play-back or access to a content item, i.e. when the appropriate license needs to be verified and enforced) it may be too late to handle any stray licenses for the content item, since not all relevant licenses may be available. This can e.g. happen because the license(s) is (are) stored on a disconnected or powered-off device or it may simply take too long to handle stray licenses properly. Especially in distributed ADs where devices of a given AD may be located at different geographical locations. The time needed for searching for and transferring licenses between devices is also increased due to the fact that content has to be transferred securely between devices e.g. using cryptographic operation, etc.

A home network like this is meant to e.g. comprise all music pieces, movies, pictures, photographs, text documents/books, etc. of every member of the household which will comprise an increasing number of content items as more and more content will be in digital form in an average household thereby giving a significant amount of content items and licenses to keep track of. The home network or the AD may also comprise a server functioning as a backup server for content and/or licenses.

Further, since track of which licenses exist for a given content item (i.e. all copies of the given content item within the AD) can be lost (e.g. due to unconnected or powered-off devices) there is no overview or easy way of determining how many (countable) rights are still left for the content item, i.e. how many times of play back is still allowed. This makes it difficult for a user to know when to purchase additional play rights, etc.

### OBJECT AND SUMMARY OF THE INVENTION

It is an object of the invention to provide a device (and corresponding method) for handling digital licenses that solves one or more of the above-mentioned shortcomings. A further object is to provide this in a simple, flexible and efficient way.

The invention provides a device (and corresponding method) for handling digital licenses, each digital license being associated with one or more content items, said device comprising a processing unit adapted to: check whether a number of licenses, being associated with a single content item or copies thereof, are designated as a stray license, where the number of licenses are present on at least one device of a group of devices, and merge the license(s) designated as stray licenses into a merged single license if the number of stray licenses is larger than 1.

In this way, re-use of stray licenses is enabled in an efficient way ensuring that a user does not get in a situation where the user is not allowed to play a given content item although a valid license still exists within the AD, due to the fact that the relevant license cannot be located by the system.

In a preferred embodiment, a given license, associated with a given content item, is designated as a stray license if said given license and the associated content item are not stored on the same device, said given license only allows partial consumption of said given content item, said given license is not stored on a device where the associated content item is accessed, said given license is not stored at a central license store, said given license is not stored on one of a predetermined number of servers in a home network, said given license is stored on a mobile phone of a user, and/or said given license is stored on a portable device.

Other schemes for designating a license as a stray license may also exist depending on a specific application.

In a preferred embodiment, each license is implemented by an XML (eXtensible Meta Language) description specifying which operations are allowed and how many times they are allowed for an associated content item.

In a preferred embodiment, said merged single license is stored on a device that stores the associated content item, on the device that had the most stray licenses stored, on a device that has a stray license stored, on a device where the associated content is accessed, at a central license store, on one of a predetermined number of servers in a home network, on a mobile phone of a user, or on a portable device.

In this way, it is ensured that the merged/collected stray licenses are readily available on a relevant device.

In a preferred embodiment, the group of devices belongs to a same Authorized Domain (AD).

In a preferred embodiment, the check for stray licenses and/or the merge is done periodically, at a predetermined interval of time and/or at a predetermined number of accesses to a content item, when a device is connected, when a user requests access to a content item, and/or when a user wants to purchase an additional license.

In this way, licenses are collected proactively and automatically minimizing the risk of that the user is left in a situation with no or a more restricted access to a content item irrespective of valid license(s).

In a preferred embodiment, the check for stray licenses and/or the merge is done using UPnP (Universal Plug and Play).

Advantageous embodiments of the method according to the present invention are defined in the sub-claims and described in detail in the following. The embodiments of the method correspond to the embodiments of the device and have the same advantages for the same reasons.

Further, the invention also relates to a computer readable medium having stored thereon instructions for causing one or more processing units to execute the method according to the present invention.

### BRIEF DESCRIPTION OF THE DRAWINGS

These and other aspects of the invention will be apparent from and elucidated with reference to the illustrative embodiments shown in the drawings, in which:

FIG. 1 schematically illustrates how devices, users, content items and licenses may be bound to an Authorized Domain (AD);

FIG. 2 schematically illustrates how stateful licenses associated with a given content item within an Authorized Domain (AD) may be split;

FIGS. 3a, 3b and 3c schematically illustrate one example of how split licenses are handled according to one embodiment of the present invention;

FIG. 4 schematically illustrates an embodiment of a device according to one embodiment of the present invention;

FIG. 5 schematically illustrates an exemplary system comprising devices and persons forming an authorized domain (AD) and working according to the present invention.

### DESCRIPTION OF PREFERRED EMBODIMENTS

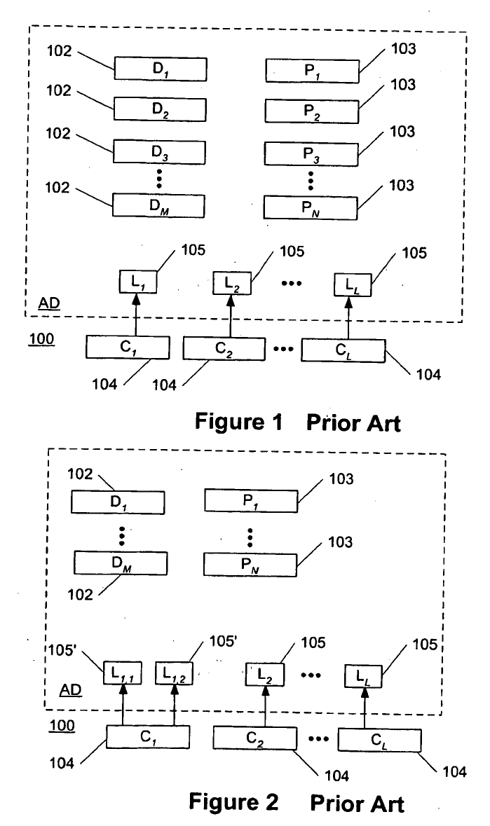

FIG. 1 schematically illustrates how devices, users, content items and licenses may be bound to an Authorized Domain (AD). Shown are an authorized domain (AD) (100) where a number of devices (102) D1, D2, D3, . . . , DM (where M is equal to or larger than 1) and a number of persons/users (103) P1, P2, P3, . . . , PN (where N is equal to or larger than 1) are bound to the AD. Also shown are one or more digital licenses (L₁, . . . L_{L}), where the licenses specify which rights a given person (and/or alternatively a given group of persons and/or all persons bound to the domain (100)) have in relation to a number of content items (104) C1, C2, C3, . . . , CL (where L is equal to or larger than 1). As mentioned above such a license may be stateful or stateless. Alternatively, a license may be associated with several content items. The license could e.g. specify the right to play a given movie (within the domain) 5 times and thus be associated with all content items within the domain being movies.

It should be noted that in practice content can only be accessed/used by means of a user operating a device. In the following, it is assumed that devices used in the system are compliant and “public” devices. This means that a device will adhere to certain operation rules (e.g. will not illegally output content on an unprotected digital interface) and that ownership of a device is not important (public). Device compliancy management, i.e. compliant device identification, renew-ability of devices, and revocation of devices, will be assumed to be in place (using known techniques), and will not be considered further here.

There typically are four main entities in such a system that could be implemented as follows:
content (C1, C2, C3, . . . , CN): content items are preferably encrypted (there are many options, for example with a unique key per content title) and can be anywhere in the system; a content item is e.g. linked directly to a license (e.g. implemented in a certificate).
Licenses (L1, . . . L_{L}): a list, certificate or the like issued by the content provider that authorizes a person to use a certain content right (R) (belonging to a certain piece of content). In principle, licenses can be anywhere in the system. In a preferred embodiment, a license may be implemented by an XML (eXtensible Meta Language) description specifying the associated right(s) by specifying which operations (e.g. record, copy once, unlimited copy, play, view, hear, etc.) are allowed and, if the right is stateful, how many times they are allowed for the associated content items. Preferably, the license also comprises rules (e.g. restricted to viewers 18 years or older, or European market only, etc.) of access to a certain content item. Derivatives/modifications of XML is e.g. DPRL (Digital Property Rights Language), XrML (eXtensible rights Markup Language), and (ODRL) Open Digital Rights Language, etc. Licenses may also comprise or be associated with cryptographic key(s) or other suitable protection means that is necessary for accessing a certain (encrypted/protected) content item.
device (D1, D2, D3, . . . , DM): a device that is used to play, operate, record, present, display, modify, etc. a content item. Additionally, a (compliant) device can also preferably identify a user by means of a personalized identification device (e.g. such as a smart-card, a mobile phone, a biometric sensor, etc.) and collect certificates (e.g. from the smartcard, or from other devices) that prove that the user is allowed to use a certain content right. This content right could be obtained from the smart-card where it was stored (if it was stored there), or be obtained (securely transferred) from another compliant device on a network.
user/person (P1, P2, P3, . . . , PN): A user is identified by some biometric or preferably by a personalized identification device (e.g. a smartcard, mobile phone, a mobile phone containing a smartcard or other types of devices that uniquely identifies a user) that he/she is wearing, carrying or has access to. A mobile phone comprising a smart card or another device having storage means is preferred since it allows users to carry rights with them (for accessing content on off-line devices). The identification device itself may be protected by a biometric authentication mechanism, so that anyone other than the legitimate owner cannot use the identification device. A user may also be identified using public key technology or zero-knowledge protocols or a combination thereof.

Preferably, authorized devices are bound to the AD (100) by a certificate, list, etc. Likewise authorized persons/users are preferably also bound to the AD (100) via a certificate, list, etc. Content items are may be bound to the AD (100) in many different ways depending on design choices. See e.g. the previous referenced documents for various implementations. Examples are e.g. that the content is bound to the devices of the domain and/or to the persons of the domain.

FIG. 2 schematically illustrates how stateful licenses associated with a given content item within an Authorized Domain (AD) may be split. Shown are an authorized domain (AD) (100) comprising a number of devices (D1, D2, D3, . . . , DM) (102), a number of persons/users P1, P2, P3, . . . , PN (103) and a number of licenses (L₁, . . . L_{L}) for a number of content items C1, C2, C3, . . . , CL (104). This figure corresponds to FIG. 1 with the exception that a license (L1 in FIG. 1) for a given content item (C1) has been split into two (or more) separate licenses (L1,1 and L1,2) (105′) for the content item (C1) which is required when the associated license(s) comprise(s) a state, i.e. implement or govern countable and/or stateful rights, and needs to be copied. The need for copying a license is e.g. when a user wants access to a content item on a portable device away (and disconnected) from the home network (as explained earlier).

In such an environment, the system may loose track of such split licenses/rights, which can result in a situation where the user is not allowed to play a given content item although a valid license/right still exists within the AD, since the license cannot be located by the system. This holds especially for distributed systems, where several devices in the AD are allowed to maintain, handle and store licenses. Situations causing this could for example be when a device storing the license is disconnected or turned-off, when the network is down and/or it simply would take to much time to merge licenses at the moment that a user requests access to a given content item.

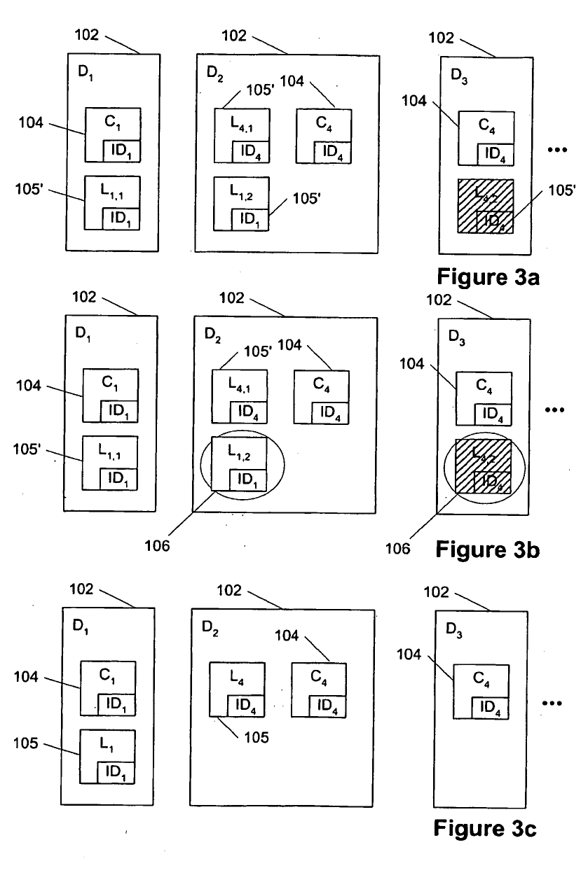

FIGS. 3a, 3b and 3c schematically illustrate an example of how split licenses are handled according to one embodiment of the present invention.

Shown in FIG. 3a are three devices D1, D2 and D3 (102), where device D1 comprises a content item C1 (104) and a split license L1,1 (105′) associated with this content item C1. Device D2 comprises content item C4 and two split licenses L4,1 and L1,2 associated with content item C4 and C1, respectively. Device D3 comprises a split license L4,2 also associated with content item C4 and further comprises content item C4 like D2 (or more correct a copy of the content item C4). The split license L4,2 specifies (in this example) a right that only allows partial consumption of (i.e. partial access to, play/view/hearing of, etc.) the associated content item C4 as indicated by being dashed. By partial consumption is meant only allowing e.g. play of 4 scenes/30 minutes of a movie that consist of 10 scenes/1 hour 15 minutes and similar examples.

In this particular embodiment, associated license(s) and content item(s) is/are bound or linked together using an identifier that is unique for the specific combination, although many other ways to do this exist. In the shown example, content item C1 and both split licenses L1,1 and L1,2 comprise the unique identifier ID1 while content item C4 (both copies on D2 and D3) and split licenses L4,1 and L4,2 comprise the unique identifier ID4.

In the following, the present invention is now explained with reference to FIGS. 3b and 3c and with FIG. 3a as a starting point situation.

FIG. 3b illustrates the same elements as FIG. 3a. According to the present invention it is determined which licenses in the system are designated or identified as stray licenses according to predetermined criteria. Preferably, a criterion for a license to be designated as a stray license (106) is that the license is not stored on the device that the associated content item is stored on, i.e. the license and the associated content item are not stored on the same device. According to this criterion license L1,2 in device D2 is a stray license (106), as indicated by a circle, since content item C1 is not present on device D2.

Another preferred criterion for a license (which may be used instead or in addition of the above) to be designated/identified as a stray license (106) according to the present invention is that the license only allows partial consumption of the associated content item. According to this criterion license L4,2 in device D3 is a stray license (106), as indicated by a circle, since L4,2 only allows partial consumption of C4 (as indicated by being dashed).

Other criteria for a license to be designated as a stray license (106) is among others e.g. that the license is not stored on the device where the content is consumed/accessed, that the license is not stored in a central license store or on one of a number of servers in the home network, that the license is stored on a portable device, and/or that the license is stored on a mobile phone of a user of the AD, and so on.

All stray licenses for a given content item are determined. This may be done for some or all content items of the system on a regular or periodic basis, e.g. on request or after a predetermined time/use interval, at a predetermined interval of time and/or at a predetermined number of accesses to a content item, when a device is connected, when a user requests access to a content item, and/or when a user wants to purchase an additional license.

The determination may be done quite simply and efficiently by searching for all licenses in the system that has the same ID number as the given content item. In FIG. 3b, the determination of relevant licenses for all present content items (C1, C4) would provide L1,1 and L1,2 for content item C1 (using ID1) and L4,1 and L4,2 for content item C4 (using ID4). Using the above criteria only L1,2 would be identified or designated as a stray license for content item C1 since D2 does not have C1 stored (and L1,2 allows complete consumption) while L4,2 would be a stray license for content item C4 even though C4 and L4,2 are stored on the same device, since L4,2 does not specify the right to complete consumption of C4.

After the stray licenses (and the other associated licenses) for each content item have been determined, the determined stray license(s) is(are) collected and merged with other stray license(s) and/or other non-stray licenses.

The licenses may be collected according to various different schemes. In one embodiment, the merged license is stored on the device that stores the associated content item. Alternatively, the merged license may be stored on the device that had the highest number of stray licenses and/or non-stray licenses stored (e.g. if several devices have the associated content item).

The result of this process is illustrated in FIG. 3c showing device D1 comprising content item C1 and (non-split non-stray) license L1, device D2 comprising content item C4 and (non-split non-stray) license L4, and device D3 only comprising content item C4 (as D2 contained the highest number of licenses associated with C4).

In this way, stray licenses are handled in a proper and efficient way ensuring re-use of stray licenses and that a user does not get in a situation where the user is not allowed to play a given content item although a valid license/right still exists within the AD, due to the fact that the relevant license cannot be located by the system.

The devices D1, D2 and D3 of this example belong to the same Authorized Domain (AD). However, the invention is just as applicable in all situations where licenses are split.

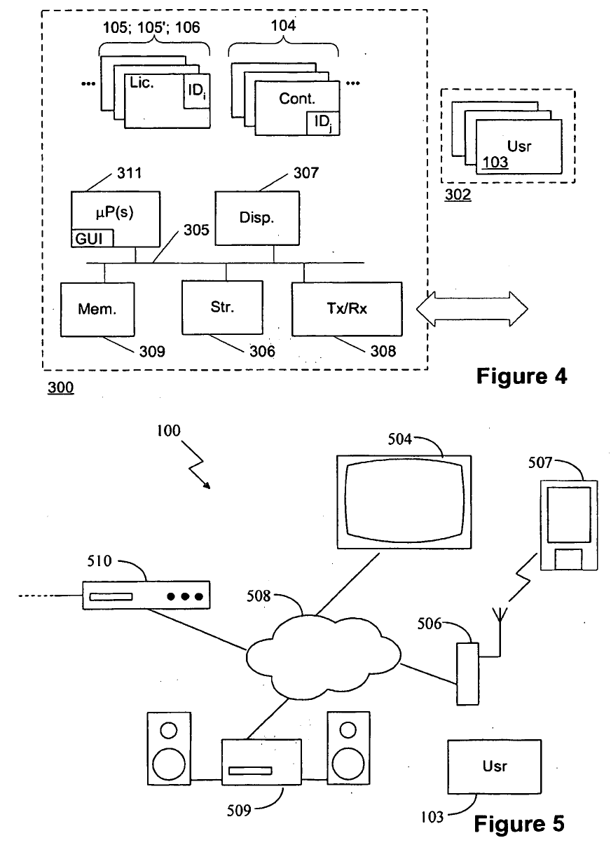

FIG. 4 schematically illustrates an embodiment of a device according to one embodiment of the present invention. Shown is a device for handling digital licenses (300) comprising or having access to one or more digital licenses (105; 105′; 106) each listing which operations are allowed and how many times they are allowed for the associated one or more content item and an ID number or similar information and one or more content items (104), as described earlier. Also shown are a number of users (103) forming a group of users (302).

The device (300) comprises a memory (309) and/or a storage (306) for short and/or long term storage of data, information, intermediate data, etc., communication means (308) e.g. for receiving content items (104) and digital licenses (105; 105′; 106), and optionally a display (307) and/or speakers (not shown) for presenting content items (104) to a user (103). The device (300) further comprises a microprocessor/a stray license identifier and merger mechanism (311) for handling the digital licenses/rights and content items according to the present invention as described earlier and in connection with FIGS. 3a-3c.

The various units may communicate via a data/information bus (305) or similar type of structures.

FIG. 5 schematically illustrates an exemplary system comprising devices and persons forming an authorized domain (AD) and working according to the present invention. Shown is network (508) that enables communication between a number of devices e.g. in a household. Devices in the example are a television set (504), a digital video system (510), a music set (509) and a portable device (507) that are in wireless (and in this particular example short-range) communication with the network (508) via a wireless access point (506). Further schematically shown is a user/person (103).

In this example, an Authorized Domain (100) has the user (103) bound to it in addition to the television set (504), the digital video (510), the music set (509), and the portable device (507) and a number of content items (not shown) where one or more of the devices act as described in connection with FIGS. 3a, 3b, 3c and 4 thereby providing re-use of stray licenses.

In the claims, any reference signs placed between parentheses shall not be constructed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A device for handling digital licenses, each digital license (105; 105′; 106) being associated with one or more content items (104), said device (300) comprising a processing unit (311) adapted to:
check whether a number of licenses (105; 105′), being associated with a single content item (104) or copies thereof, are designated as a stray license (106), where the number of licenses (105; 105′) are present on at least one device (102) of a group of devices (D₁, . . . , D_{M}), and
merge the license(s) designated as stray licenses (106) into a merged single license (105) if the number of stray licenses (106) is larger than 1.

2. A device according to claim 1, characterized in that a given license (105; 105′), associated with a given content item (104), is designated as a stray license (106) if
said given license (105; 105′) and the associated content item (104) are not stored on the same device (102),
said given license (105; 105′) only allows partial consumption of said given content item (104),
said given license (105; 105′) is not stored on a device where the associated content item (104) is accessed,
said given license (105; 105′) is not stored at a central license store,
said given license (105; 105′) is not stored on one of a predetermined number of servers in a home network,
said given license (105; 105′) is stored on a mobile phone of a user, and/or
said given license (105; 105′) is stored on a portable device.

3. A device according to claim 1, characterized in that each license (105; 105′; 106) is implemented by an XML (eXtensible Meta Language) description specifying which operations are allowed and how many times they are allowed for an associated content item (104).

4. A device according to claim 1, characterized in that said merged single license (105) is stored
on a device (102) that stores the associated content item (104),
on the device (102) that had the most stray licenses stored,
on a device (102) that has a stray license stored,
on a device (102) where the associated content is accessed,
at a central license store,
on one of a predetermined number of servers in a home network,
on a mobile phone of a user, or
on a portable device.

5. A device according to claim 1, characterized in that said group of devices (D₁, . . . , D_{M}) belongs to a same Authorized Domain (AD) (100).

6. A device according to claim 1, characterized in that said check for stray licenses (106) and/or said merge is done
periodically,
at a predetermined interval of time and/or at a predetermined number of accesses to a content item,
when a device is connected,
when a user requests access to a content item, and/or
when a user wants to purchase an additional license.

7. A device according to claim 1, characterized in that said check for stray licenses (106) and/or said merge is done using UPnP (Universal Plug and Play).

8. A method of handling digital licenses, each digital license (105; 105′; 106) being associated with one or more content items (104), said method comprising the steps of:
checking whether a number of licenses (105; 105′), being associated with a single content item (104) or copies thereof, are designated as a stray license (106), where the number of licenses (105; 105′) are present on at least one device (102) of a group of devices (D₁, . . . , D_{M}), and
merging the license(s) designated as stray licenses (106) into a merged single license (105) if the number of stray licenses (106) is larger than 1.

9. A method according to claim 8, characterized in that the method further comprises the step of designating a given license (105; 105′), associated with a given content item (104), as a stray license (106) if
said given license (105; 105′) and the associated content item (104) are not stored on the same device (102),
said given license (105; 105′) only allows partial consumption of said given content item (104),
said given license (105; 105′) is not stored on a device where the associated content item (104) is accessed,
said given license (105; 105′) is not stored at a central license store,
said given license (105; 105′) is not stored on one of a predetermined number of servers in a home network,
said given license (105; 105′) is stored on a mobile phone of a user, and/or
said given license (105; 105′) is stored on a portable device.

10. A method according to claim 8, characterized in that each license (105; 105′; 106) is implemented by an XML (eXtensible Meta Language) description specifying which operations are allowed and how many times they are allowed for an associated content item (104).

11. A method according to claim 8, characterized in that the method further comprises the step of storing said merged single license (105)
on a device (102) that stores the associated content item (104),
on the device (102) that had the most stray licenses stored,
on a device (102) that has a stray license stored,
on a device (102) where the associated content is accessed,
at a central license store,
on one of a predetermined number of servers in a home network,
on a mobile phone of a user, or
on a portable device.

12. A method according to claim 8, characterized in that said group of devices (D₁, . . . , D_{M}) belongs to a same Authorized Domain (AD) (100).

13. A method according to claim 8, characterized in that said step of checking for stray licenses (106) and/or said step of merging is/are done
periodically,
at a predetermined interval of time and/or at a predetermined number of accesses to a content item,
when a device is connected,
when a user requests access to a content item, and/or
when a user wants to purchase an additional license.

14. A method according to claim 8, characterized in that said step of checking for stray licenses (106) and/or said step of merging are done using UPnP (Universal Plug and Play).

15. A computer readable medium having stored thereon instructions for causing one or more processing units to execute the method according to any one of claims 8-14.
